(19) United States
(12) Patent Application Publication
(10) Pub. No.: US 2024/0419925 A1
(43) Pub. Date: Dec. 19, 2024

(54) AUTO-TUNING READING PASSAGES USING GENERATIVE ARTIFICIAL INTELLIGENCE

(71) Applicant: Microsoft Technology Licensing, LLC, Redmond, WA (US)

(72) Inventors: Shay BEN-ELAZAR, Herzliya (IL); Ella BEN TOV, Tel Aviv (IL); Yossef Hai BEN DAVID, Tel Aviv (IL); Merav MOFAZ, Tel Aviv (IL); Shira SIDON COHEN, Ramat Gan (IL); Daniel SITTON, Tel Aviv (IL)

(21) Appl. No.: 18/336,447

(22) Filed: Jun. 16, 2023

(51) Int. Cl. G06F 40/58; G06F 40/51

(52) U.S. Cl. CPC G06F 40/58; G06F 40/51

(57) ABSTRACT

Technology is disclosed herein for an application for generating and auto-tuning reading passages. A method of operating an application includes generating a prompt which elicits a reply from a foundation model service that includes a reading passage tailored to the ability of a reader. The prompt includes instructions for generating the reading passage using one or more trouble words and according to a desired readability. The desired readability is based on one or more indicators of a reader's reading ability. The application assesses the readability of the reading passage, resulting in an assessed readability. The application generates a follow-on prompts with which to elicit follow-on replies from the foundation model service that includes a request to adjust the reading passage based on the assessed reliability. The application enables display of the adjusted reading passage in a user interface of the application.

### TECHNICAL FIELD

Aspects of the disclosure are related to the field of computer software applications and, in particular, to technological solutions for reading instruction.

### BACKGROUND

Classroom instruction, including reading instruction, is increasingly situated in online environments. Many software tools exist for creating groups, assigning tasks, and otherwise managing a classroom online, but reading instruction remains the same as in the offline world. For example, a teacher may connect with a student on a video conference call and have the student read selected text aloud. Just as in the physical classroom, the teacher listens to the student read and provides feedback over the call.

In any class, there are as many reading abilities as there are students. The teacher faces the challenge of addressing the many variations in ability in a class while shepherding the students toward competency. Students may exhibit competency in some language areas but need additional practice in other areas according to their individual abilities. Students who become proficient readers will need the challenge of more sophisticated language materials to continue building proficiency. However, reading and language instruction tools are often designed based on a general expectation or understanding about students' ability according to age or grade level which provides, at best, a relatively rough estimation of ability for, in many classes, a highly diverse range of reading ability.

### OVERVIEW

Technology is disclosed herein for an application for generating reading passages for reading instruction and practice. A method of operating an application includes generating a prompt which elicits a reply from a foundation model service that includes a reading passage tailored to the ability of a reader. The prompt includes instructions for generating the reading passage using one or more trouble words and according to a desired readability. The desired readability is based on one or more indicators of the reading ability of the reader. The application assesses the readability of the reading passage, resulting in an assessed readability. The application generates a second prompt with which to elicit a second reply from the foundation model service that includes a request to adjust the reading passage based on the assessed reliability. The application enables display of the adjusted reading passage in a user interface of the application.

In an implementation, the request to adjust the reading passage includes a request to make the reading passage more difficult or less difficult when the assessed readability is below or above, the desired readability, respectively. In an implementation, the application enables display of the adjusted reading passage after a maximum number of adjustments to the reading passage.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational example of a foundation model integration for customized reading passages in a reading application environment in an implementation.

FIG. 2 illustrates a method of operating a reading application with a foundation model integration for customized reading passages in an implementation.

FIG. 3 illustrates a systems architecture for a foundation model integration for customized reading passages in a reading application environment in an implementation.

FIG. 4 illustrates an operational scenario of operating a reading application with a foundation model integration for customized reading passages in an implementation.

FIGS. 5A-5G illustrate user experiences of an operational scenario of a foundation model integration for customized reading passages in a reading instruction application in an implementation.

FIGS. 6A and 6B illustrate user experiences of an operational scenario of a foundation model integration for customized reading passages in a reading instruction application in an implementation.

FIG. 7 illustrates prompt templates for a foundation model integration for customized reading passages in an implementation.

FIG. 8 illustrates a computing system suitable for implementing the various operational environments, architectures, processes, scenarios, and sequences discussed below with respect to the other Figures.

### DETAILED DESCRIPTION

Technology is disclosed herein for a foundation model integration for generating age- or grade-appropriate reading passages in an application environment, such as an environment directed to reading practice or instruction. Reading passages are generated according to a chain of prompts conditioned on the readability of the reading passage. The prompt chain instructs a foundation model service to create a reading passage, then to modify the passage to achieve a desired readability (i.e., level of reading difficulty).

In an implementation, an application service displays a user interface in which a user, such as a teacher, can request and receive a custom reading passage configured according to characteristics of a target audience (e.g., student reader) and which includes one or more trouble words, i.e., words identified as troublesome for the target audience learning to read. The application service generates a prompt for a foundation model service which instructs the foundation model service to compose the custom reading passage at a desired readability that is appropriate for the given characteristics of the target audience. The application service submits the prompt to the foundation model service and receives a reading passage generated according to the prompt.

Upon receiving the reading passage from the foundation model service, the application service assesses the readability of the reading passage. If the assessed readability of the passage is at or within a margin of error of the desired readability, the application service displays the custom reading passage to the user, such as in an environment for creating reading assignments for students. If, however, the assessed readability of the custom reading passage is above or below the desired readability beyond a margin of error (i.e., the custom reading passage is more difficult or less difficult than the desired readability), the application service generates a follow-on prompt tasking the foundation model service with adjusting or tuning the reading passage so its readability is closer to the desired readability. The follow-on prompt may include previous versions of the reading passage along with corresponding readability assessments of the previous versions to guide the foundation model service in narrowing in on the desired readability.

Upon receiving an adjusted reading passage in a second reply from the foundation model service, the adjusted reading passage is again assessed for readability. If the assessed readability is within the margin of error of the desired readability, the custom reading passage is configured for display to the user. If, however, the assessed readability is still beyond the margin of error, another prompt is generated tasking the foundation model service with again adjusting the reading passage so its readability within acceptable bounds of the desired reading passage.

In some implementations, the cycle of adjusting the reading passage is repeated until the desired readability is achieved or until a maximum number of adjustment cycles has occurred, at which point the adjustment cycle is exited and the reading passage is configured for display. For example, the application service may submit a reading passage for adjustment up to two times (subsequent to passage generation), then display the latest version of the reading passage with no further adjustment. Limiting the number of adjustment cycles avoids excess latency degrading the user experience as well as costs associated with excessive foundation model usage.

Foundation models of the technology disclosed herein include large-scale generative artificial intelligence (AI) models trained on massive quantities of diverse, unlabeled data using self-supervised, semi-supervised, or unsupervised learning techniques. Foundation models may be based on a number of different architectures, such as generative adversarial networks (GANs), variational auto-encoders (VAEs), and transformer models, including multimodal transformer models. Foundation models capture general knowledge, semantic representations, and patterns and regularities in or from the data, making them capable of performing a wide range of downstream tasks. In some scenarios, a foundation model may be fine-tuned for specific downstream tasks. Foundation models include BERT (Bidirectional Encoder Representations from Transformers) and ResNet (Residual Neural Network). Foundation models may be multimodal or unimodal depending on the modality or modalities of the inputs (discussed infra). Types of foundation models may be broadly classified as or include pre-trained models, base models, and knowledge models, depending on the particular characteristics or usage of the model.

Multimodal models are a class of foundation model which leverages the pre-trained knowledge and representation abilities of foundation models to extend their capabilities to handle multimodal data, such as text, image, video, and audio data. Multimodal models may leverage techniques like attention mechanisms and shared encoders to fuse information from different modalities and create joint representations. Learning joint representations across different modalities enables multimodal models to generate multimodal outputs that are coherent, diverse, expressive, and contextually rich. For example, multimodal models can generate a caption or textual description of the given image, for example, by using an image encoder to extract visual features, then feeding the visual features to a language decoder to generate a descriptive caption. Similarly, multimodal models can generate an image based on a text description (or, in some scenarios, a spoken description transcribed by a speech-to-text engine). Multimodal models work in a similar fashion with video-generating a text description of the video or generating video based on a text description.

Multimodal models include visual-language foundation models, such as CLIP (Contrastive Language-Image Pre-training), ALIGN (A Large-scale ImaGe and Noisy-text embedding), and VILBERT (Visual-and-Language BERT), for computer vision tasks. Visual multimodal or foundation models also include DALL-E, DALL-E 2, Flamingo, Florence, and NOOR. Types of multimodal models may be broadly classified as or include cross-modal models, multimodal fusion models, and audio-visual models, depending on the particular characteristics or usage of the model.

Large language models (LLMs) are a unimodal type of foundation model which processes and generates natural language text. These models are trained on massive amounts of text data and learn to generate coherent and contextually relevant responses given a prompt or input text. LLMs are capable of sophisticated language understanding and generation capabilities due to their trained capacity to capture intricate patterns, semantics and contextual dependencies in textual data. In some scenarios, LLMs can incorporate additional modalities, such as combining images or audio with textual input to generate multimodal outputs. Types of LLMs include language generation models, language understanding models, and transformer models.

Transformer models, including transformer-type foundation models and transformer-type LLMs, are a class of deep learning models used in natural language processing (NLP). Transformer models are based on a neural network architecture which uses self-attention mechanisms to process input data and capture contextual relationships between words in a sentence or text passage. Transformer models weigh the importance of different words in a sequence, allowing them to capture long-range dependencies and relationships between words. GPT (Generative Pre-trained Transformer) models, ERNIE (Enhanced Representation through kNowledge Integration) models, T5 (Text-to-Text Transfer Transformer), and XLNet models are types of transformer models which have been pretrained on large amounts of text data using a self-supervised learning technique called masked language modeling. Indeed, large language models, such as ChatGPT and its brethren, have been pretrained on an immense amount of data across virtually every domain of the arts and sciences. This pretraining allows the models to learn a rich representation of language that can be fine-tuned for specific NLP tasks, such as text generation, language translation, or sentiment analysis. Moreover, these models have demonstrated emergent capabilities in generating responses which are novel, open-ended, and unpredictable.

In some implementations, the technology disclosed herein incorporates a foundation model service hosting a foundation model, such as a multimodal model service hosting a multimodal model, to teach a variety of subjects beyond reading instruction, such as subjects in the social sciences (e.g., history, geography), scientific subjects (e.g., biology, chemistry, astronomy), math subjects (e.g., geometry, statistics, game theory), or subjects in the visual arts, (e.g., fine art appreciation, photography, art history). In an implementation, prompts including selected text and/or imagery can be fed into a multimodal instructional environment to generate customized text or images for instructional activities, such as identifying a protein conformation, graphing or charting data for analysis, map reading, geometric proofs, and so on.

Technology disclosed herein may be implemented in the education context. In the education context, the existing Reading Progress module of the application service may be used in combination with the OpenAIR application programming interface (API) and an education (EDU) API layer. Known trouble words can be obtained from the Reading Progress module using the Microsoft Insights platform. The trouble words are submitted to an EDU API that sits atop the OpenAI API to generate targeted reading passages that incorporate the trouble words with some frequency. The passage initiator (e.g., teacher or instructor) may also select a category of the reading passage, a passage length, age range, language, and other factors.

In an exemplary scenario, an application executing on a user computing device presents a user interface in which a user, such as a teacher, reading coach, or reading instructor, configures a reading assignment based on a custom reading passage. In the user interface, the application displays trouble words, i.e., words which are determined to be troublesome as related to a student's reading ability. The trouble words are identified, in some scenarios, by a speech engine, such as Microsoft Insights, based on speech data for students learning to read or improving their reading skills. The user interface of the application receives user input which indicates a selection of the trouble words to include in the reading passage. The application service may task the foundation model service with including words that are similar to the trouble words or words that include troublesome phonemes or illustrate troublesome phonetic rules in the bespoke reading passage.

The user interface may also receive user input relating to characteristics to further individualize the custom reading passage such as topic, genre, age level of the reader, passage length, difficulty, language, and so on. In some implementations, the application may identify a location of the user based on, for example, an Internet Protocol (IP) address, and configure a default language based on the detected location.

The application service generates a prompt based on a prompt template selected according to the type of request. For example, when a customized reading passage is to be created by the foundation model service, the application service selects a prompt template which includes rules or tasks governing how the passage is to be created. The prompt template may include characteristics selected by the user according to the reading ability of the reader. Characteristics can include, for example, a desired readability, such as a reader age, age-range, reading age, or grade level of the target audience. Other rules specified in the prompt template can include trouble words selected by the user which were identified by reading coach or speech engine based on an audio reading sample of the reader. In some implementations, the prompt template may be configured to include a set of words entered by the user, such as vocabulary associated with another area of study. The prompt template may also specify an output format such as plain text, or a structured format such as JavaScript Object Notation (JSON) data structure, an extensible Markup Language (XML) syntax, or the use of semantic tags (e.g., <passage> and </passage>) defined in the prompt.

The prompt may include other rules or instructions for the foundation model service in responding to the prompt, such as evaluating the passage for inappropriate content and language. The prompt may instruct the foundation model service in some scenarios to generate factual content and to evaluate the content for accuracy. The prompt may also direct the foundation model service to localize the passage by incorporating cultural phenomenon (e.g., names, places, landmarks, foods, modes of transportation, animals, weather, geography, historical figures) based on a detected location of the computing device or for a location specified by the user. For example, a prompt received from a computing device in France will direct the foundation model service to localize the passage to what would be familiar to French students or typical of or common to a student's life in France.

Upon submitting the prompt to the foundation model service, the application service receives output from the foundation model service including the requested passage. The application service parses the output to extract the reading passage and performs operations or checks on the passage. In an implementation, the application service validates that the selected trouble words are included in the passage and performs content moderation operations with regard to the appropriateness of the content.

Having received the reading passage generated by the foundation model service according to the prompt, the application service analyzes the extracted reading passage with respect to readability or to the desired readability. In an implementation, the application service generates one or more scores based on readability analysis algorithms. The readability analysis algorithms take into account linguistic and structural features of the text to estimate its readability level. The readability level may be specified in terms of an age, reading age, or grade level of the target reader. The algorithms are based on models or analytical tools such as Flesch Kincaid, Flesch Reading Ease, Gunning Fog, Simple Measure of Gobbledygook (SMOG), Coleman-Liau Index, Automated Readability Index (ARI), Linscar Write Formula, Dale-Chall, Spache Readability, McAlpine EFLAW, Reading Time, and so on. While some readability models are applicable to multiple languages (e.g., Gunning Fog or Flesch Reading Ease), other models are specific for some non-English languages, such as, for Spanish text, Índice de lecturabilidad Fernandez-Huerta, Índice de perspicuidad de Szigriszt-Pazos, Fórmula de comprensibilidad de Gutiérrez de Polini, and Fórmula de Crawford. Other algorithms for generating linguistic metrics can be used to determine passage readability, such as a syllable count, word or lexicon count, sentence count, character count, letter count, polysyllable count, monosyllable count, and so on.

The outputs of the various readability analysis models or tools can include an age range, grade level estimate, or other score reflecting an ease of reading of the reading passage. For example, the grade level estimate may be an integer value reflecting a rough equivalent to an average reading ability of students at that grade level. The grade level estimate may also be a decimal value, e.g., a score of 9.3 would reflect a ninth-grade reading ability.

In an exemplary scenario, an aggregation of readability algorithms and/or linguistic metrics is used to generate an assessed readability of the reading passage which can be compared to the desired readability identified based on the characteristics of the reader, such as the grade level of the reader. For example, a weighted average of multiple scores may be used to generate an estimated readability of the reading passage, such as an estimated grade level of the student, with the weights configured to minimize bias or other confounding factors. In some implementations, the grade estimation is also determined according to the country of the reader. For example, 4th grade reading age in the United States is roughly equivalent to Grade 3 reading age in the United Kingdom.

The application service may also perform content moderation operations on the output from the foundation model service. For example, the application service may evaluate the reading passage to validate that the trouble words are included in the passage. The application service may also evaluate the reading passage with respect to the appropriateness of the language (e.g., that the passage contains no offensive content). If a content moderation operation or trouble word validation yields an unsatisfactory result, the application service may generate a follow-on prompt, based on the appropriate prompt template, tasking the foundation model service with modifying the reading passage to satisfy content moderation or trouble word instructions.

With the reading passage analyzed by one or more reading models, an assessed readability for the reading passage is generated based on an aggregate readability score, such as a grade level estimation. The application service compares the assessed readability with the desired readability. For example, the grade level estimation of the reading passage is compared to the grade level identified according to the characteristics of the reader or target audience supplied in the user input. In an implementation, the assessment includes a margin of error in determining whether the assessed readability satisfies or is comparable to the desired readability. If the assessed readability does not satisfy or is not comparable to the desired readability, the application service may configure a follow-on prompt, based on the appropriate template, to modify the reading passage. In an exemplary scenario, if the assessed readability is more than one grade level below the desired readability, the application service may select a prompt template which tasks the foundation model service with modifying the reading passage to increase the level of difficulty of the passage. The prompt template may include specific tasks or suggestions for the foundation model service to change the readability of the reading passage, such as lengthening or shortening sentences, using words of greater or lesser complexity, etc.

Upon submitting the follow-on prompt, including the to-be-adjusted reading passage, to the foundation model service, the application service receives a reply with an adjusted reading passage from the foundation model service. The application service assesses the readability of the adjusted reading passage with respect to the desired readability as well as performing content moderation operations and trouble word validation. If the assessed readability of the adjusted reading passage is still beyond the margin of error of the desired readability, the application service may generate yet another prompt tasking the foundation model service with again adjusting the (most recent) reading passage. The follow-on prompts may include the original and subsequent adjusted versions of the reading passage along with the assessed readability scores or grade level estimates to guide the foundation model service in adjusting the reading passage to achieve the desired readability. For example, the prompt may include a data structure containing the original and adjusted versions of the reading passage along with the readability scores of the versions, the data structure being a JSON object, corresponding data vectors, or a two-dimensional data array.

In some implementations, the application service may perform multiple adjustment cycles to configure the reading passage, an adjustment cycle including sending an adjustment prompt to the foundation model service, receiving an adjusted reading passage, and performing a readability assessment of the adjusted reading passage. In some implementations, because repeated adjustment cycles may increase latency and potentially degrade the user experience, the application service may limit the number of adjustments to be performed on a reading passage. For example, when a reading passage has been twice revised the foundation model service, the application service may cease further adjustments by the foundation model service and proceed with enabling display of the reading passage in the user interface.

When the desired readability is reached, the application service displays the passage in the user interface and presents the user with options for configuring a reading assignment based on the passage. In some implementations, the trouble words selected by the user or the user-specified vocabulary are highlighted in the prompt for the user's convenience. The user interface may also present an option for modifying the user input and generating a new passage, such as changing the length of the passage or the level of difficulty. In some scenarios, the user can export the foundation model-generated passage in a file such as a Word document or Portable Document Format (PDF), or copy/paste the passage into another application, such as an email message, for other handling.

In some implementations, the trouble words to be incorporated by the foundation model service into the reading passage include words with phonics or phonemes identified by the reading coach or speech engine as troublesome for the student reader learning to read. For example, the user may be presented in the user interface with phonics or letter combinations detected by the speech engine as ones with which the target audience is prone to making reading errors. The user may indicate, among various characteristics of the reader, words which incorporate difficult or troublesome phonics, letter combinations, or phonemes identified by the speech engine.

To configure an assignment based on the custom reading passage, the application service presents a number of options to configure how student readers can complete the assignment, such as implementing a time limit or number of attempts. In particular, the user may select to incorporate the use of the speech engine as part of the assignment. The speech engine captures and analyzes audio input of a student reader reading the passage, providing the user with feedback specific to a particular student's reading ability relating to the trouble words or phonics.

In other implementations of the disclosed technology, the application service presents a self-guided reading context in the user interface to a student reader or an individual seeking reading practice or instruction outside of an instructional context. For example, for individuals looking to improve their reading abilities, vocabulary, oral language skills, etc., the technology may be incorporated into applications for self-guided instruction and practice. In the self-guided reading context, the reader initiates the generation of custom reading passages according to selections or user input provided by the reader.

In an implementation of a self-guided application, the reader may be initially evaluated by a reading coach component or speech engine, and the application may prompt the foundation model service with generating reading passages according to an assessment of the reader's ability (e.g., identification of the reader's trouble words). The reader may be prompted in an interface to provide information relating to the reader's goals, reading ability, or education (e.g., the reader's highest level of education completed). The interface may also present the reader with a number of options for how the reading passages are to be configured, such as indicating a genre, a topic of interest or writing style (e.g., humorous, informal, educational), level of difficulty, and length. For example, the reader may elect to create a short story which incorporates the reader's trouble words, that is, words identified by the application as ones on which the reader should have additional practice.

Having received the user input and the trouble words identified by the reading coach, the application service generates and submits a prompt for creating a reading passage according to the user input and a desired readability based on characteristics of the reader. The application service assesses the readability of the reading passage received from the foundation model service with respect to the desired readability. If the assessed readability does not match the desired readability or is beyond a margin of error of the desired readability, the application service submits a follow-on prompt to adjust or tune the reading passage to make it more or less difficult according to the desired and assessed readabilities. In an implementation, when the desired readability is achieved or a maximum number of adjustments have been performed, the application service enables display of the reading passage to the reader in the self-guided reading context.

The application of the application service may be a stand-alone application or integrated in the context of another application, operating system, or computing environment. For example, the application may be implemented as an application natively installed and executing on a user computer or a browser-based application running in the context of a web browser. In some implementations, the application may execute within the context of a collaboration or conferencing application, such as Microsoft Teams®.

Technical effects which may be appreciated from the technology disclosed herein include a streamlined process and interface by which reading assignments can be individually tailored according to the reader's ability by integrating automated reading analysis tools (e.g., speech engines) to create customized reading passages on demand and by automatically tuning the reading passages to achieve a desired readability specific for a student reader. Customizing the requested passage according to age, grade level, or other metric relating to reading ability allows the teacher to use techniques such as scaffolded learning to gradually introduce new or more difficult vocabulary to a student reader according to the reader's individual learning style or ability.

In addition, the technology supervises the generated content to ensure the student is presented with safe and appropriate content according to the student's reading ability. Post-processing the custom reading passages according to a carefully targeted readability ensures adequate support for graduated learning strategies. Moreover, post-processing the custom reading passages for appropriateness of the content safeguards the reading environment for the student reader.

Still other technical advantages may be appreciated from the disclosed technology. Prompts tailored according to the disclosed technology reduce the amount of data traffic between the application service and the foundation model service for generating useful content for a reader. For example, the disclosed technology streamlines the interaction between the user (e.g., a teacher) and the application service by generating prompts which keep the foundation model service on task and reduce the incidence of erroneous, inappropriate, or off-target replies. The disclosed technology also promotes more rapid convergence, that is, reducing the number of interactions with the foundation model to generate a desired result.

In addition, the disclosed technology focuses the generative activity of the foundation model to improve the performance of the foundation model service without overwhelming the foundation model service (e.g., by exceeding a token limit). For example, the disclosed technology balances prompt size (e.g., the number of tokens in the prompt which must be processed by the foundation model service) with providing sufficient information to generate a useful response. Other technical benefits accruing from streamlined interaction, more rapid convergence, and optimized prompt sizing include reduced data traffic, faster performance by the foundation model service, reduced latency, and concomitant improvements to productivity costs and to the end-user experience.

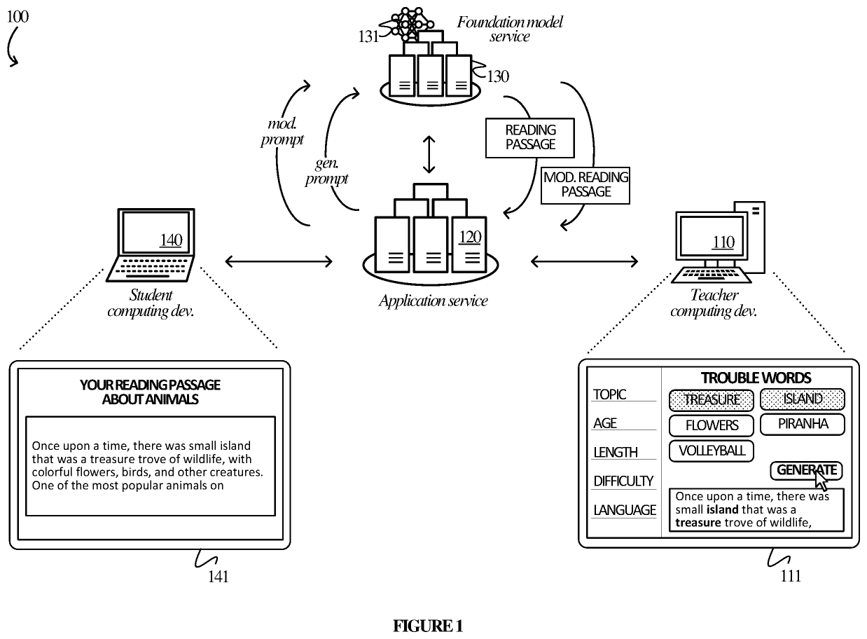

FIG. 1 illustrates operational environment 100 for an application service with a foundation model integration for generating customized or personalized reading passages in an implementation. Operational environment 100 includes application service 120 which communicates with teacher computing device 110, student computing device 140, and Foundation model service 130. Application service 120 hosts a reading instruction application for endpoints such as teacher computing device 110 and student computing device 140. Teacher computing device 110 and student computing device 140 execute applications that provide a local user experience and that interface with application service 120. The reading instruction application of application service 120 may be implemented in a natively installed and executed application, and may execute in a stand-alone manner, within the context of another application such as a collaboration or conferencing application, or in some other manner entirely.

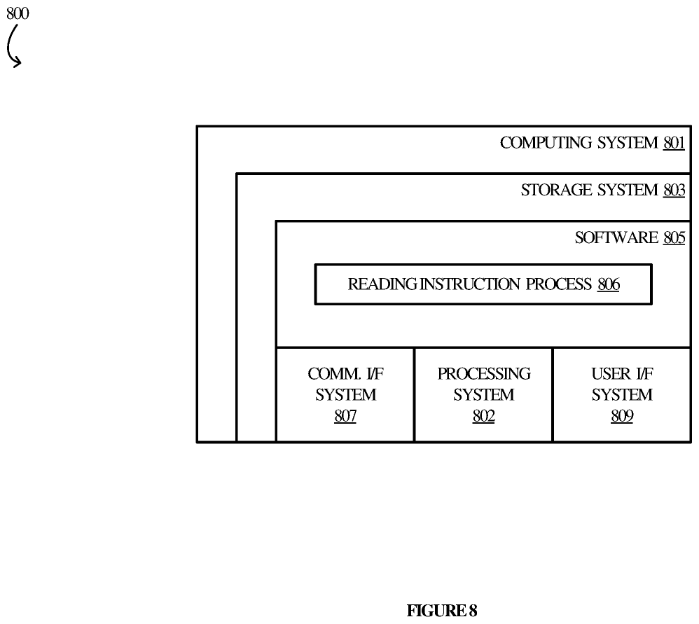

Teacher computing device 110 and student computing device 140 are representative of computing devices, such as laptops or desktop computers, mobile computing devices, such as tablet computers or cellular phones, and any other suitable devices of which computing device 801 in FIG. 8 is broadly representative. Teacher computing device 110 and student computing device 140 communicate with application service 120 via one or more internets and intranets, the Internet, wired or wireless networks, local area networks (LANs), wide area networks (WANs), and any other type of network or combination thereof. A user interacting with teacher computing device 110 interacts with the reading instruction application of application service 120 via a user interface of the application displayed on teacher computing device 110. User experience 111 is representative of a user experience of an assignment creation environment of a reading instruction application hosted by application service 120 in an implementation.

Application service 120 is representative of one or more computing services capable of hosting a reading instruction application and interfacing with teacher computing device 110 and student computing device 140. Application service 120 may be implemented in software in the context of one or more server computers co-located or distributed across one or more data centers. Examples of services or sub-services of application service 120 include—but are not limited to—voice and video conferencing services, collaboration services, file storage services, and other application services. In some examples, application service 120 may provide a suite of applications and services with respect to a variety of computing workloads such as office productivity tasks, email, chat, voice and video, and so on.

Application service 120 employs one or more server computers co-located or distributed across one or more data centers connected to student computing device 140 and teacher computing device 110. Examples of such servers include web servers, application servers, virtual or physical servers, or any combination or variation thereof, of which computing device 801 in FIG. 8 is broadly representative. Application service 120 may communicate with student computing device 140 and teacher computing device 110 via one or more internets, intranets, the Internet, wired and wireless networks, LANs, WANs, and any other type of network or combination thereof.

Foundation model service 130 is representative of one or more computing services capable of hosting a foundation model computing architecture and communicating with application service 120. Foundation model service 130 may be implemented in the context of one or more server computers co-located or distributed across one or more data centers. Foundation model service 130 hosts foundation model 131 which is representative of a deep learning AI model, such as GPT-3®, GPT-3.5, ChatGPT®, or GPT-4, BERT, ERNIE, T5, XLNet, or other multimodal or unimodal model, interfaces with application service 120 to receive prompts associated with input received from user experience 111 and to generate and return replies to application service 120 including reading passages.

In an exemplary operation of operational environment 100, a user (e.g., a teacher) at teacher computing device 110 wishes to create a reading assignment for a student. Teacher computing device 110 hosting a reading instruction application receives a set of trouble words from application service 120. As illustrated in user experience 111, the teacher elects to generate a custom reading passage for a reading assignment. The reading application displays the set of trouble words along with parameters for generating a custom reading passage for the assignment. In an implementation, the set of trouble words are words which have been empirically determined by a speech engine of application service 120 to be difficult, challenging, or troublesome to read for the student. In user experience 111, the teacher selects trouble words and enters parameters to further customize the reading passage according to characteristics of the reader, such as age, passage length, and level of difficulty. Upon clicking the graphical button “Generate,” the reading instruction application of teacher computing device 110 submits a request to application service 120 for a custom reading passage based on the selected trouble words and reader characteristics.

Application service 120 receives the request for a custom reading passage from teacher computing device 110 and determines a desired readability for the reading passage based on the reader characteristics supplied in the input. For example, the teacher may specify the custom reading passage to be of higher difficulty for an 11-year-old student or for a fifth-grade student. Application service 120 determines that the desired readability of the passage based on the user inputs is a grade level range of 5.5-6.4. Application service 120 generates a prompt for Foundation model service 130 including the selected trouble words and the desired readability. In specifying the desired readability in the prompt, application service 120 may indicate the grade level range (5.5-6.4), the characteristics associated with the reader (fifth grade student reading at a moderate level of difficulty), or both. The prompt may also specify other user inputs, for example, a passage length of 200-300 words and a topic or genre. Application service 120 submits the prompt to foundation model service 130.

Upon receiving the prompt, foundation model service 130 generates a custom reading passage according to the prompt and returns the custom reading passage to application service 120. Application service 120 receives the custom reading passage and assesses the readability of the passage according to one or more readability analysis models to generate an assessed readability for comparison to the desired readability. Application service 120 also examines the passage based on criteria such as appropriateness of the content (e.g., that the passage contains no offensive content), the level of difficulty, the frequency of use of the trouble words, and so on.

It is assumed for the purpose of illustration that application service 120 determines that the assessed readability of the custom reading passage received from foundation model service 130 is 6.8, that is, outside a range of acceptable values for the desired readability. Application service 120 generates a follow-on prompt which tasks foundation model service 130 with modifying the custom passage to achieve the desired readability, e.g., making the reading passage easier to read. Application service 120 sends the follow-on prompt to foundation model service 130 and receives in return a modified reading passage.

Assuming once again for the purpose of illustration that application service 120 determines the assessed readability is 6.0, the assessed readability of the modified reading passage is within the desired range of readability. Based on the acceptable readability of the modified reading passage, application service 120 presents the modified reading passage to the teacher in user experience 111. In user experience 111, the teacher views the reading passage and configures a reading assignment based on the modified reading passage for the student. In user experience 141 of student computing device 140, the student views the modified reading passage in the context of the reading assignment created by the teacher.

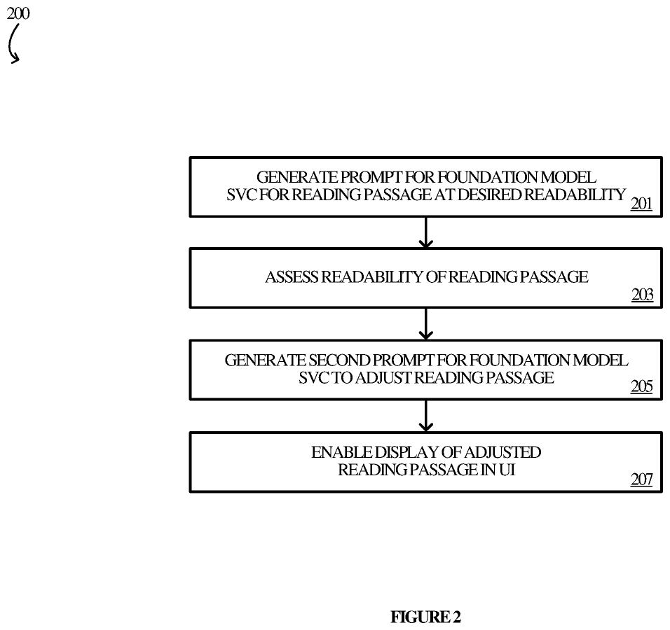

FIG. 2 illustrates a method of operating an application service for reading instruction with a foundation model integration in an implementation, hereinafter referred to as process 200. Process 200 may be implemented in program instructions in the context of any of the software applications, modules, components, or other such elements of one or more computing devices. The program instructions direct the computing device(s) to operate as follows, referred to in the singular for clarity.

The computing device generates a prompt for the foundation model service tasking the foundation model service with generating a reading passage at desired readability (step 201). In an implementation, the computing device hosts an application for reading instruction and displays a user interface for the application. In the user interface, the computing device receives input characteristics related to the reading ability of a reader or other target audience. Based on the input characteristics, the computing device determines a desired readability for the reading passage. For example, the desired readability may be a decimal or integer value approximately equivalent to a grade or grade range. Upon receiving the user input including a request for a custom reading passage, the computing device generates the prompt for the foundation model service.

In some implementations, the prompt also includes selected words or phonics and tasks the foundation model service with incorporating the words or words containing the phonics in the reading passage. For example, the application service may identify trouble words relating to one or more students' reading ability. To identify trouble words, the application service may use a speech engine which captures audio of a student reader and detects words with which the reader is having difficulty in reading or pronouncing. The speech engine generates a list of recommended words or phonics which the speech engine determines would be beneficial for the reader(s) to practice. In some implementations, the user may enter words or vocabulary for the reading prompt.

In some implementations, the computing device may automatically generate the prompt, such as when the application launches on the computing device or when the reader, in a self-guided context, has demonstrated sufficient aptitude relating to a reading assignment and is ready for a new, more difficult reading passage. The computing device may generate the prompt to include a desired readability based on data relating to the reader's reading ability, such as a historical record of the reader's reading activity. The prompt may also include words identified by a speech engine or reading coach based on audio sample of the reader reading a passage. In various implementations, the computing device automatically generates the prompt in the context of a reading instruction application or a self-guided application for reading practice or tutelage.

In an implementation, the prompt may further task the foundation model with constraining its output to content which is appropriate for the target audience according to age and reading level, and to localize the content according to a location detected by the computing device or a location specified by the user. The prompt may instruct the foundation model service to provide a custom reading passage of a particular word length (e.g., 150 to 250 words) and to craft the content of the reading passage according to a particular topic or genre. The prompt may direct the foundation model to identify and include words which are similar to the trouble words, for example, to increase the level of difficulty of the reading passage. The prompt may further instruction task the foundation model with generating a title for the custom reading passage or to write the passage in a particular style, such as humorous, with alliteration, etc.

The prompt generated by the application service may also instruct the foundation model service to avoid certain types of content, such as content, language, or subject matter which may be personally or culturally insensitive or inappropriate. The prompt may also task the foundation model service with output its custom reading passage in a particular format by which the application service can parse the output to retrieve the passage or to tag the trouble words or words including the trouble phonics so the application service can highlight them in the display in the user interface.

Having generated a prompt requesting a reading passage, the computing device submits the prompt to the foundation model service and receives in return output from the foundation model service including a reading passage. In some implementations, the prompt is submitted via an API supported by the foundation model service.

The computing device assesses the readability of the reading passage from the foundation model service (step 203). Upon receiving the output, in an implementation, the computing device parses the output from the foundation model service to extract the reading passage and evaluate the readability of the reading passage. To evaluate the readability of the passage, the computing device may execute computing functions which evaluate text according to readability analysis models. For example, the computing functions may generate metrics or scores relating to the readability of the reading passage. The computing device aggregates the multiple scores to produce an assessed readability of the reading passage, such as an average of the scores or a score range based on the scores. The assessed readability may be the same type of metric as the desired readability, such as a decimal or integer value approximately equivalent to a grade or grade range, so that when the assessed readability is compared to the desired readability, a difference can be computed by which to determine whether the passage is to be revised by the foundation model service.

If/when the assessed readability does differ from the desired readability, the computing device generates a second prompt for the foundation model service to adjust the reading passage (step 205). In an implementation, if the assessed readability is outside a range of acceptable readability values based on the desired readability or if the difference between the two values exceeds a threshold value, the computing device generates a prompt including the reading passage received from the foundation model service along with a request to make the passage easier or more difficult with respect to readability. The prompt may include the desired readability and the assessed readability of the reading passage to provide an indication to the foundation model service of how much the reading passage is to be adjusted to achieve the desired readability. The prompt may also include instructions for how the passage can be adjusted, such as using longer or shorter sentences, simpler or more complex vocabulary, etc. With the second prompt configured, the computing device submits the second prompt to the foundation model service and receives a second reply including an adjusted reading passage.

Upon receiving the second reply, the computing device enables a display of the adjusted reading passage in the user interface of the application (step 207). In an implementation, the computing device assesses the readability of the adjusted reading passage. Upon determining that the assessed readability satisfies the desired readability, the computing device configures a display of the reading passage in the user interface of the reading instruction application. In the user interface, the user can view the reading passage and configure a reading assignment for the target audience for whom the passage was created. In some implementations, the computing device displays the reading passage with the trouble words or user-specified vocabulary highlighted.

In various implementations, the computing device displays the reading passage in an assignment creation environment. The assignment creation environment provides the user, such as a teacher, with options for configuring an assignment based on the reading passage, such as specifying a due date or time limit, a number of attempts, the use of a reading coach or speech engine for feedback on student performance of the assignment, and so on. The environment may present the teacher with adding or modifying the content of the reading passage, such as adding or modifying a title of the passage. In some implementations, the teacher can save the reading passage and add tags to the passage by which the teacher can search for the passage for other assignments. In some implementations, the teacher can also print the reading passage or export the passage to a Word document or PDF. The computing device may also present the user with an option to generate an entirely new reading passage if the teacher so desires.

Referring back to FIG. 1, operational environment 100 includes a brief example of process 200 as employed by elements of operational environment 100, such as application service 120, teacher computing device 110, and foundation model service 130. In an implementation, a client application for reading instruction executes on teacher computing device 110.

In operation, application service 120 receives user input at the client application including characteristics relating to the reading ability of a reader for whom a reading passage is to be generated. In an implementation, the user at teacher computing device 110 inputs information or parameters relating to the reader's reading ability, such as an age or grade level of the reader. The user input may also specify a level of difficulty of the reading passage, along with other parameters such as a passage length, a topic, a genre, and so on. Application service 120 determines a desired readability based on the parameters relating to the reader's reading ability.

Application service 120 also receives user input from teacher computing device 110 which identifies a selection of trouble words to be included in the reading passage. In an implementation, to identify trouble words for the reading passage, application service 120 receives trouble words identified by a speech engine which captures audio data of a student reading a passage and analyzes the data to identify words, letters, or phonics with which the student has some difficulty reading. Application service 120 displays the trouble words identified by the speech engine and receives user input in the user interface indicating a selection of one or more of the trouble words for inclusion in the reading passage. In some implementations, the user may enter words for inclusion in the reading passage, such as vocabulary associated with another, concurrent area of study.

Application service 120 configures a prompt for submission to foundation model service 130 based on a prompt template for passage generation according to readability and including selected vocabulary. The prompt tasks foundation model service 130 with generating a reading passage according to the desired readability and incorporating the trouble words. In some implementations, the prompt includes parameters according to which foundation model service 130 generates the passage with respect to length and difficulty or with respect to characteristics of the intended reader. The prompt may include rules relating to moderating the content to avoid including inappropriate or offensive material.

Application service 120 submits the prompt to foundation model service 130 and receives a reading passage generated by foundation model service 130 based on the prompt. Application service 120 evaluates the reading passage to determine if the readability of the passage matches or is sufficiently close to the desired readability. For example, application service 120 may determine that the desired readability is 3.4, i.e., appropriate for a third-grade student and that an assessed readability within one grade level of the desired readability (2.4 to 4.4) satisfies the readability requirement.

Continuing the exemplary scenario, if the assessed readability is outside the range of 2.4 to 4.4, application service 120 generates a second prompt which tasks foundation model service 130 with adjusting the reading passage. In an implementation, application service 120 selects a prompt template according to the assessed readability and desired readability and configures a prompt based on the template. The prompt includes the original reading passage along with the assessed readability. The prompt tasks foundation model service 130 with adjusting the reading passage by making the passage easier or more difficult with respect to readability. For example, if the assessed readability is 2.1, application service 120 selects a prompt template for revising the reading passage to make it more difficult. On the other hand, if the assessed readability is 4.5, application service 120 selects a prompt template for revising the reading passage to make it less difficult. Each template may include rules or suggestions for how foundation model service 130 can accomplish the revision.

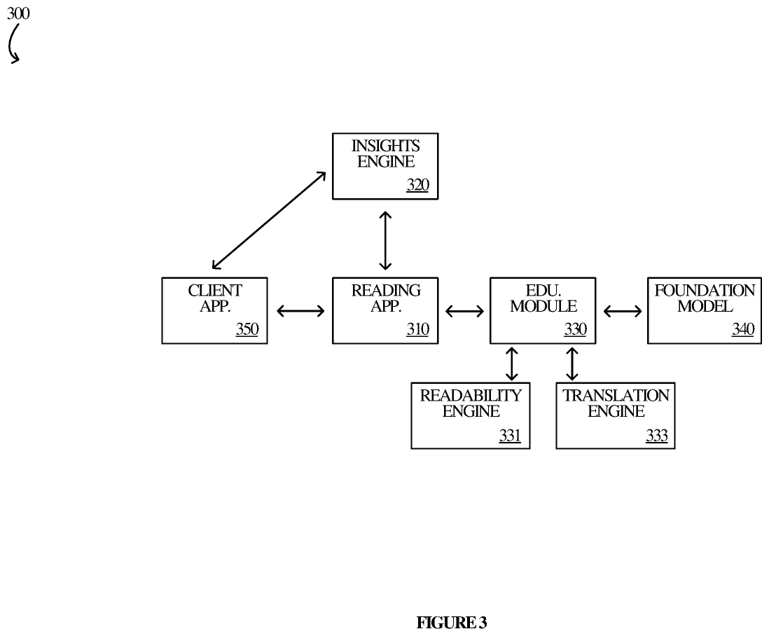

FIG. 3 illustrates systems architecture 300 in an implementation of a foundation model integration with a reading instruction service, such as application service 120 of FIG. 1. Systems architecture 300 includes reading application 310, insights engine 320, education module 330, readability engine 331, translation engine 333, foundation model 340, and client application 350.

Reading application 310 provides one or more services relating to reading instruction and is representative of any application capable of running on a computing device, such as a desktop or laptop computer or mobile device, and interfacing with an online service such as insights engine 320 and education module 330. Reading application 310 may be a stand-alone application or may be integrated in the context of another application, an operating system, or other such environment. Reading application 310 may also be a natively installed and executed application, a browser-based application that runs in the context of a web browser, a streaming (or streamed) application, a mobile application, or any other type of application.

Insights engine 320 provides one or more services relating to reading instruction to endpoints such as client application 350 and reading application 310. Examples of such services include—but are not limited to—capturing or receiving audio data relating to reading instruction, such as recorded audio of a student reading aloud a selected passage, and analyzing the audio data to generate insights into words, sounds, phonemes, or phonetic rules which the student is having some difficulty in reading. In an implementation, insights engine 320 is a specific-purpose artificial intelligence (AI) module which executes independently of foundation model 340. Insights engine 320 may execute on one or more server computers co-located or distributed across one or more data centers connected to computing devices on which client application 350 or reading application 310 operate. While contemplated as a sub-service of reading application 310 or client application 350, insights engine 320 may also be implemented as a separate service independent from reading application 310 or client application 350. In an implementation, reading application 310 may interface with insights engine 320 via an API.

Education module 330 of systems architecture 300 provides one or more services relating to reading instruction. Examples of such services include—but are not limited to—configuring prompts for generating custom reading passages by foundation model 340 and receiving and configuring output from foundation model 340 for display in reading application 310 and/or client application 350. For example, education module 330 may create a prompt tasking foundation model 340 with generating and/or revising a custom reading passage according to a specified level of difficulty and based on words (e.g., trouble words) identified by insights engine 320. Education module 330 may execute on one or more server computers co-located or distributed across one or more data centers connected to computing devices on which client application 350 or reading application 310 operate. While contemplated as a sub-service of reading application 310 or client application 350, education module 330 may also be implemented as a separate service independent from reading application 310 or client application 350. Similarly, insights engine 320 and education module 330 may each be implemented independent of each other. In an implementation, reading application 310 may interface with education module 330 via an API.

Education module 330 is operatively coupled with readability engine 331. Readability engine 331 provides services relating to reading instruction to endpoints such as client application 350 and reading application 310. Examples of such services include—but are not limited to—evaluating the readability of a reading passage, such as a reading passage generated by foundation model 340; determining a readability based on characteristics of a reader; and comparing an assessed readability of a reading passage with a desired readability associated with a target audience for the reading passage to ascertain if the readability of the reading passage is adequate or appropriate for the target audience. In an implementation, readability engine 331 executes computer functionality for generating one or more readability scores for a reading passage and generating a composite score based on the one or more readability scores. Readability engine 331 may execute on one or more server computers co-located or distributed across one or more data centers connected to computing devices on which client application 350 or reading application 310 operate. While contemplated as a sub-service of education module 330, readability engine 331 may also be implemented as a separate service independent from education module 330.

Education module 330 is also operatively coupled with translation engine 333. Translation engine 333 provides services relating to reading instruction to endpoints such as client application 350 and reading application 310. Examples of such services include—but are not limited to—translating foreign-language user input received by reading application 310 into English and translating an English language text, such as a reading passage generated by foundation model 340, into a foreign language. In an implementation, translation engine 333 executes computer functionality for performing language translation into English or another language. Translation engine 333 may execute on one or more server computers co-located or distributed across one or more data centers connected to computing devices on which client application 350 or reading application 310 operate. While contemplated as a sub-service of education module 330, translation engine 333 may also be implemented as a separate service independent from education module 330.

Foundation model 340 is representative of one or more computing services capable of hosting a foundation model computing architecture and communicating with education module 330 and/or reading application 310. Foundation model 340 may be implemented in the context of one or more server computers co-located or distributed across one or more data centers. Foundation model 340 hosts a deep learning AI model, such as ChatGPT®, BERT, ERNIE, T5, XLNet, and the like, which is integrated with a reading instruction environment associated with reading application 310 and/or client application 350.

Client application 350 provides one or more services relating to reading instruction and is representative of any application capable of running on a computing device, such as a desktop or laptop computer or mobile device, and interfacing with an online service such as reading application 310 and insights engine 320. Client application 350 may be a stand-alone application or may be integrated in the context of another application, an operating system, or other such environment. Client application 350 may also be a natively installed and executed application, a browser-based application that runs in the context of a web browser, a streaming (or streamed) application, a mobile application, or any other type of application.

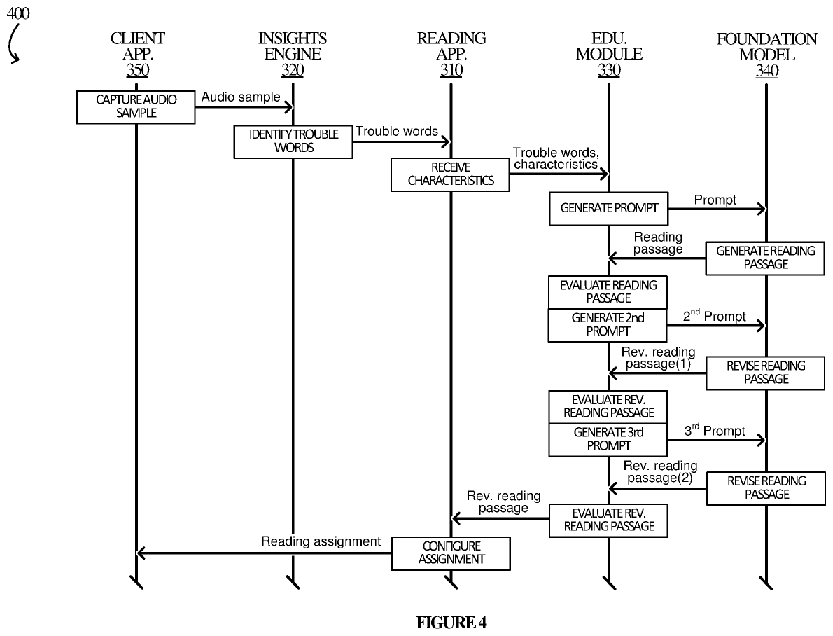

FIG. 4 illustrates operational scenario 400 with respect to the elements of FIG. 3 in an implementation. Operational scenario 400 illustrates a chain of prompts configured by education module 330 tasking foundation model 340 with generating and revising a custom reading passage, wherein the prompt chaining results from foundation model 340 failing to achieve the desired readability.

In operation, client application 350 executes an audio capture functionality to capture an audio recording of a student reading a selected passage. Client application 350 sends the audio sample data to insights engine 320 for analysis. Insights engine 320 determines from the audio data a set of words, phonemes, or phonetic rules which the student has demonstrated some measure of difficulty, challenge, or trouble in reading, such as in pronunciation or prosody. Insights engine 320 provides the data set to reading application 310.

Reading application 310 receives the set of trouble words and configures the user interface to display the trouble words, phonemes, or phonetic rules to the teacher or reading instructor. In the user interface, the teacher elects to create a reading assignment including a custom reading passage incorporating one or more of the trouble words or words including the troublesome phonemes or phonetic rules detected by insights engine 320. The user interface of reading application 310 also receives selections indicative of parameters for configuring a custom reading passage for the reading assignment, such as a topic for the passage, length, level of difficulty, student's age or age range, student's grade, language, topic, genre, and so on. Upon receiving the selections of trouble words, phonemes, or phonetic rules and the reading passage parameters, reading application 310 submits the selections to education module 330.

Education module 330 receives the reading passage parameters and determines a target or desired readability for the reading passage based on characteristics of the target audience. Education module 330 also receives the selected trouble words, phonemes, and/or phonetic rules and parameters, from reading application 310. Education module 330 generates a prompt for foundation model 340 which tasks foundation model 340 with generating a reading passage drafted according to the desired readability and including the trouble words. Education module 330 submits the prompt to foundation model 340 which generates a reading passage in accordance with the rules or instructions in the prompt.

Foundation model 340 returns output to education module 330 which extracts the requested reading passage. Education module 330 assesses the readability of the reading passage and compares the assessed readability to the desired readability. In some implementations, education module 330 also executes a content moderation layer which evaluates the reading passage for appropriate content and a validation layer which validates the inclusion of the selected trouble words in the passage.

For the purpose of illustration, it is assumed that education module 330 determines that the reading passage is too difficult. In other words, education module 330 determines that readability of the reading passage generated by foundation model 340 exceeds the desired readability or is greater than the upper limit of an acceptable range of readability. Education module 330 generates a second prompt which tasks foundation model 340 with revising the reading passage to make the passage easier to read, such as by using shorter sentences or simpler vocabulary. Education module 330 submits the second prompt to foundation model 340 and receives a revised reading passage.

When education module 330 receives the revised reading passage, it evaluates the readability of the revised reading passage. Again, for the purpose of illustration, it is assumed that the readability of the revised reading passage is now too easy. In other words, education module 330 evaluates the revised reading passage and determines that the assessed readability is below the desired readability or below the lower limit of the acceptable readability range. Based on the evaluation, education module 330 generates a third prompt tasking foundation model 340 with revising the revised reading passage to heighten the difficulty, such as by using longer sentences, more multisyllabic words, and so on. The third prompt includes the original reading passage and the revised reading passage along with the readability assessments of those versions.

In response to the third prompt, foundation model 340 generates a third version of the reading passage and sends the newly revised passage to education module 330. Education module 330 determines that the third version now satisfies the readability requirement according to the characteristics of the reader or target audience. Education module 220 transmits the third version of the reading passage to reading application 310 for display in the user interface.

Reading application 310 generates a display of the reading passage in the user interface including highlighting the trouble words incorporated into the passage. In the user interface of reading application 310, the teacher is presented with the custom reading passage along with a set of configuration options for creating a reading assignment based on the custom reading passage. When the teacher has configured the reading assignment and submitted it for distribution, reading application 310 propagates the assignment to client application 350 for the student to complete.

In an implementation, upon receiving a third version of the reading passage, and subject to content moderation, education module 330 is limited to receiving three versions of the reading passage, at which point it sends the third version of the reading passage to reading application 310 irrespective of the assessed readability. Implementing a limit on the number of revisions to be performed on a reading passage prevents excess latency in the user experience as well as limiting operational costs associated with the chain of prompts.

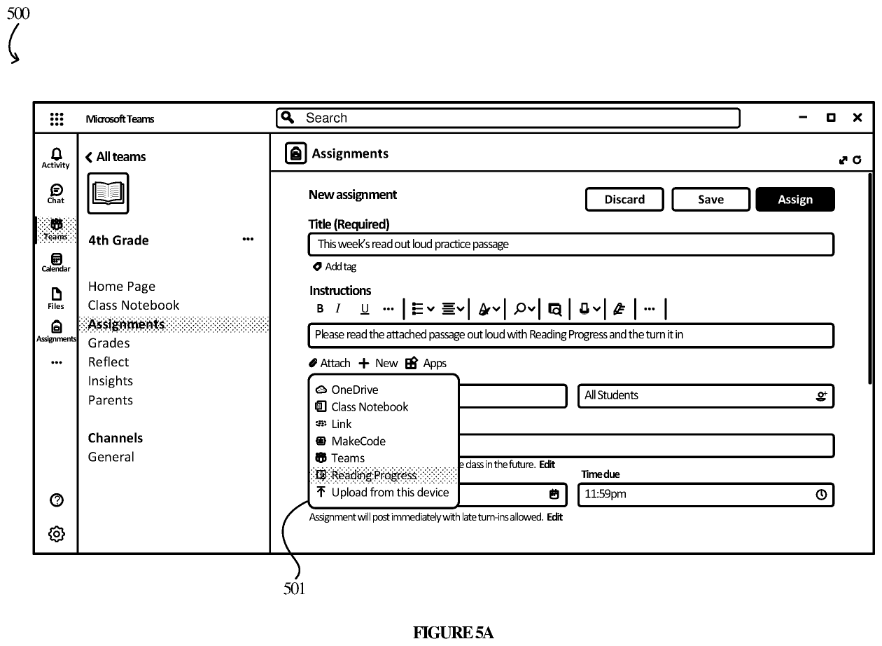

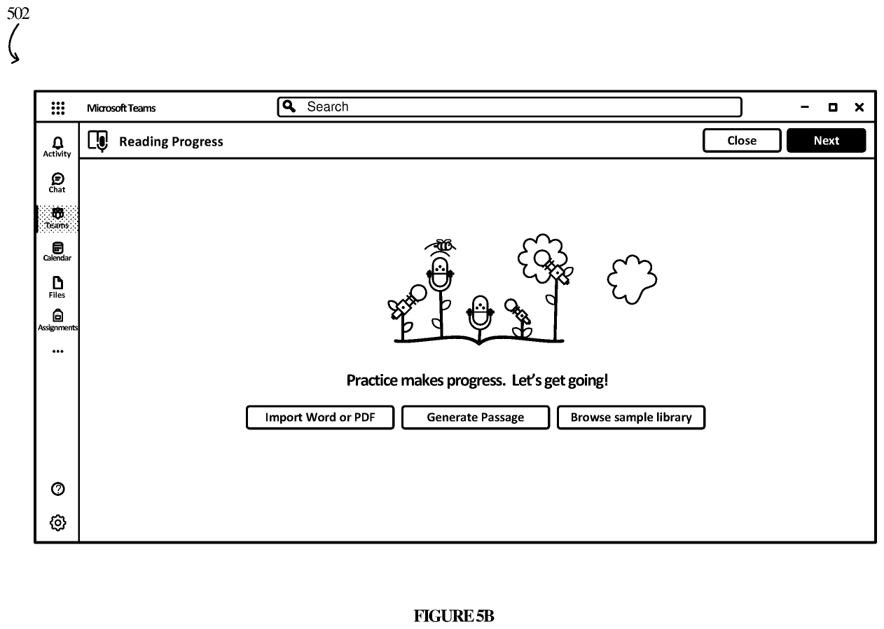

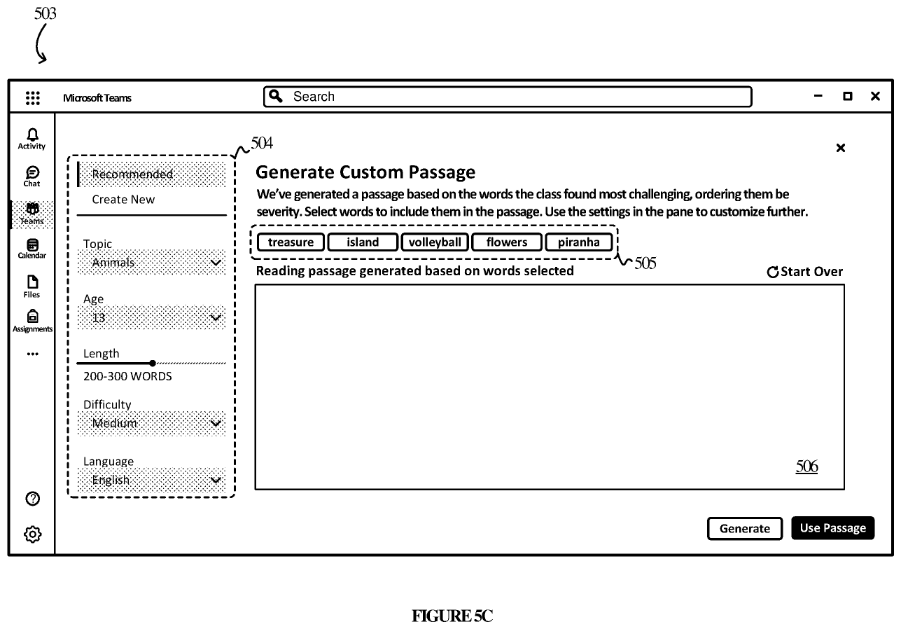

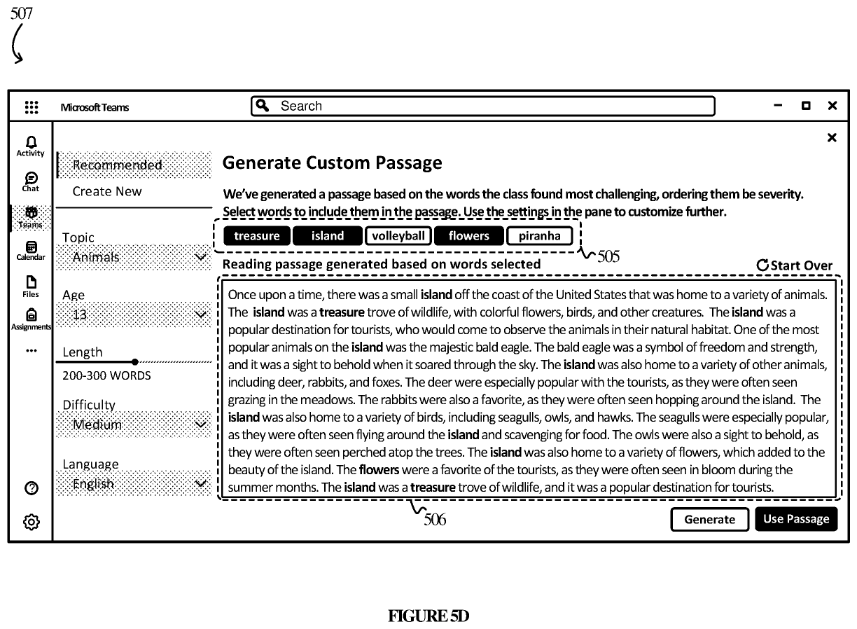

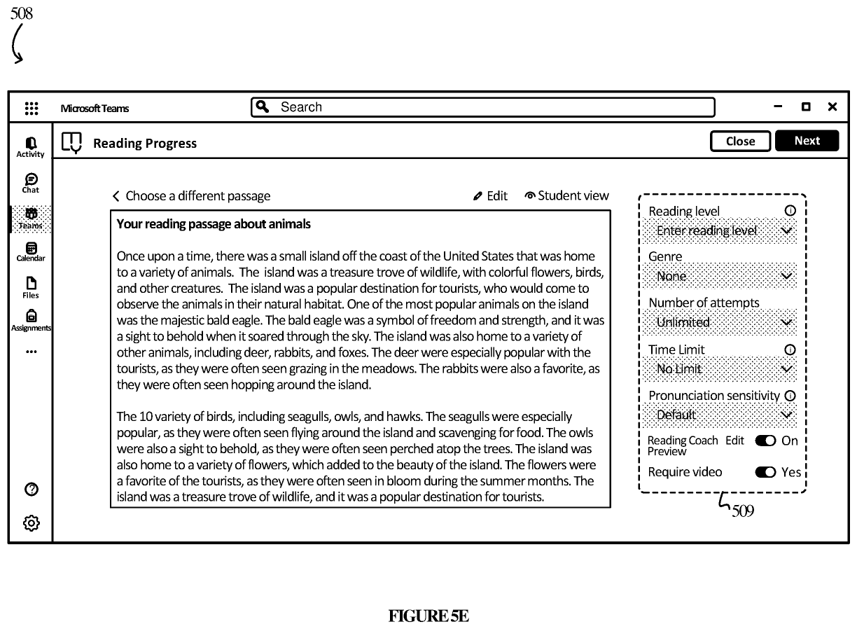

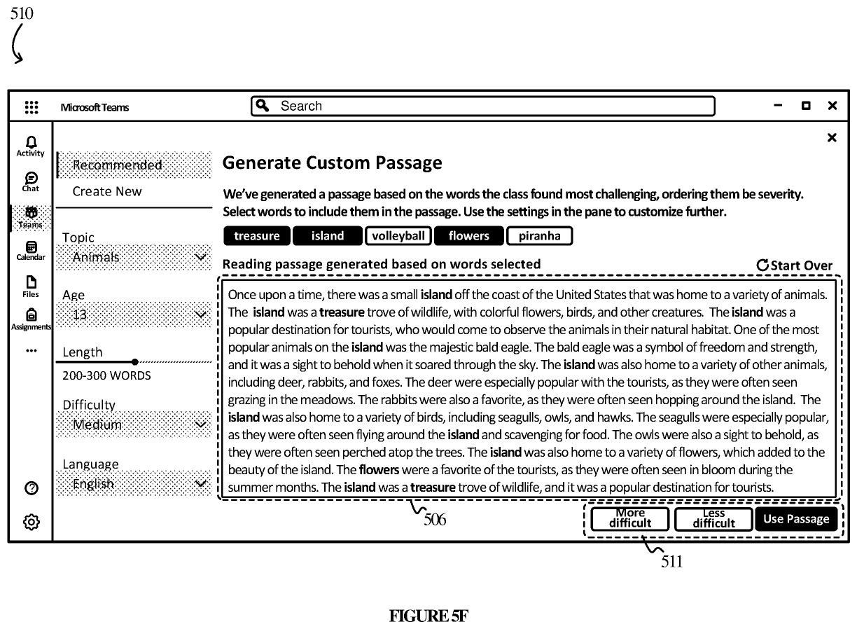

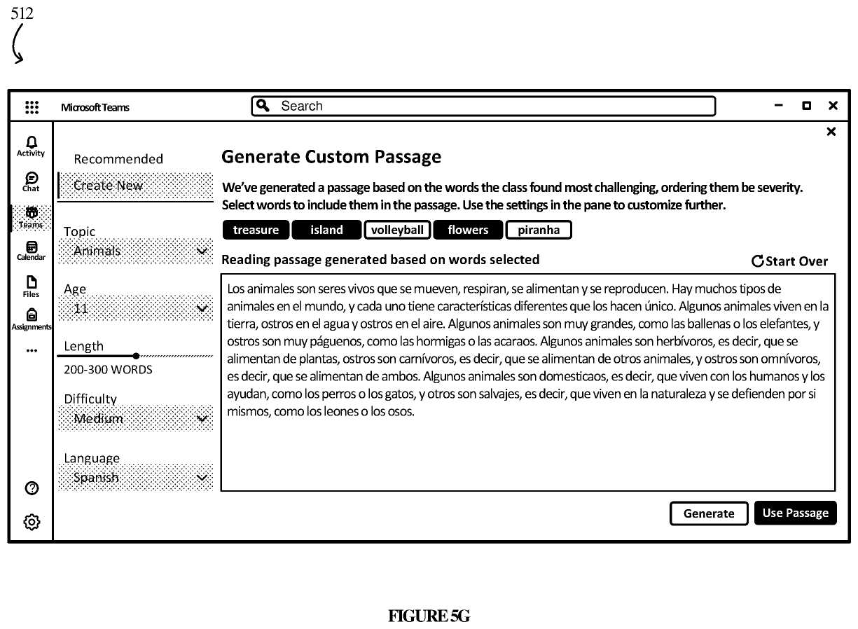

FIGS. 5A-5G illustrate exemplary user experiences 500-506 in an implementation that is representative of the user experiences discussed above for an application service with a foundation model integration. In a brief example of the technology disclosed herein, user experience 500 illustrates a user interface generated and displayed by a reading instruction application on a computing device. As illustrated in FIG. 5A, the reading instruction application may execute within the context of a collaborative application, examples of which include Microsoft® Teams. The user interface displays an assignment creation environment and includes drop-down menu 501 by which a teacher can select to create a Reading Progress assignment.

FIG. 5B continues with user experience 502 illustrating a user interface generated and displayed by the application when the user selects the Reading Progress assignment type in drop-down menu 501. As illustrated in FIG. 5B, the teacher or other user can import a Word document or PDF file containing reading text, generate a custom reading passage based on select words and/or reading parameters, or browse a sample library of reading texts.

In FIG. 5C, user experience 503 illustrates a user interface generated and displayed by the application when the user selects the “Generate Passage” graphical button shown in FIG. 5B.

In configuration pane 504, the teacher can include parameters which specify characteristics of the reading passage, for example, based on the characteristics of the target audience or reader(s). In configuration pane 504, the teacher can select to create new customized reading passage based on the specified parameters or to receive a reading passage recommended by the application based on, for example, reading ability data captured by the speech engine. The teacher can specify the reader age (or reading age), passage length, and level of difficulty of the custom reading passage by which the application will determine a desired readability. The desired readability will inform the foundation model of a foundation model service, such as an LLM of an LLM service, with respect to the sophistication of the vocabulary, sentence length, subject matter selection, and other linguistic factors in composing the passage.

Continuing with FIG. 5C, in user experience 503, the teacher is also presented with trouble words 505, that is, words identified by a speech engine of the application, such as Microsoft Insights operating in conjunction with Microsoft Teams, as being the most challenging for a class and presented in the order of severity as determined by the speech engine. The teacher can select from among trouble words 505 for generating a custom reading passage.

In user experience 503 of FIG. 5C, the teacher can also select a topic, such as Animals, Sports, Plants, Travel, Occupations, or a user-specified topic, and/or the language of the passage, such as English, Spanish, French, and so on. Other options for configuring the custom reading passage may be presented to the teacher as well, such as including a second topic, localizing the custom reading passage to a particular state or country, a genre (such as fictional, non-fiction, historical, adventure, etc.) or other vocabulary selected by the teacher to include in the passage. Upon clicking the “Generate” graphical button, the application configures a prompt based at least on the inputs received in user experience 503 and displays output received from a foundation model service in output pane 506.

Continuing the exemplary operational scenario of FIGS. 5A-5F, in user experience 507 of FIG. 5D, the application displays in output pane 506 a custom reading passage generated based on the prompt configured by the application based on the user or teacher input. The custom reading passage may be the output resulting from a chain of prompts tasking the foundation model service with generating and revising the reading prompt to achieve a desired readability. The custom reading passage includes the three selected words of trouble words 505 highlighted in bold in the passage. In user experience 507, the teacher can modify parameters of configuration pane 504 or the selection of trouble words from among trouble words 505 and request a new custom reading passage. Upon clicking the “Use Passage” graphical button, the application displays user experience 508 of FIG. 5E.

Continuing with user experience 508 in FIG. 5E, the teacher can configure a reading assignment based on the custom reading passage received from the foundation model service. In configuration pane 509, the teacher can input tags or selections for classifying the reading passage for later use, such as in other assignments. For example, the teacher can indicate a reading level of the passage and a genre as well as other assignment parameters. Also in configuration pane 509, the teacher can indicate the number of attempts which students are allowed to make in completing the assignment and a time limit or due date for completing the assignment. The teacher can also include the speech engine or other pronunciation service to capture audio data of a student reading the passage aloud and analyze the audio data to provide feedback on the student's performance. The teacher can fine-tune the speech engine with regard to its sensitivity to students' pronunciation. The teacher can also create an assignment which records video of one or more attempts by the student to complete the assignment.

FIGS. 5F and 5G illustrate alternative implementations of user experience 507 illustrated in FIG. 5D. User experience 510 of FIG. 5F includes graphical input buttons 511 by which the teacher can, upon reviewing the reading passage generated by the foundation model service, manually elect to make the reading passage more or less difficult. In an implementation, if the teacher elects to make the reading passage more difficult, for example, the application receives the user input and configures a prompt for the foundation model service to generate a reading passage according to a higher readability (i.e., higher level of reading difficulty) than originally specified. In user experience 512 in FIG. 5G, the teacher has requested a custom reading passage in Spanish. FIG. 5G illustrates the custom reading passage generated by the foundation model service and translated into Spanish by a translation engine of the application.

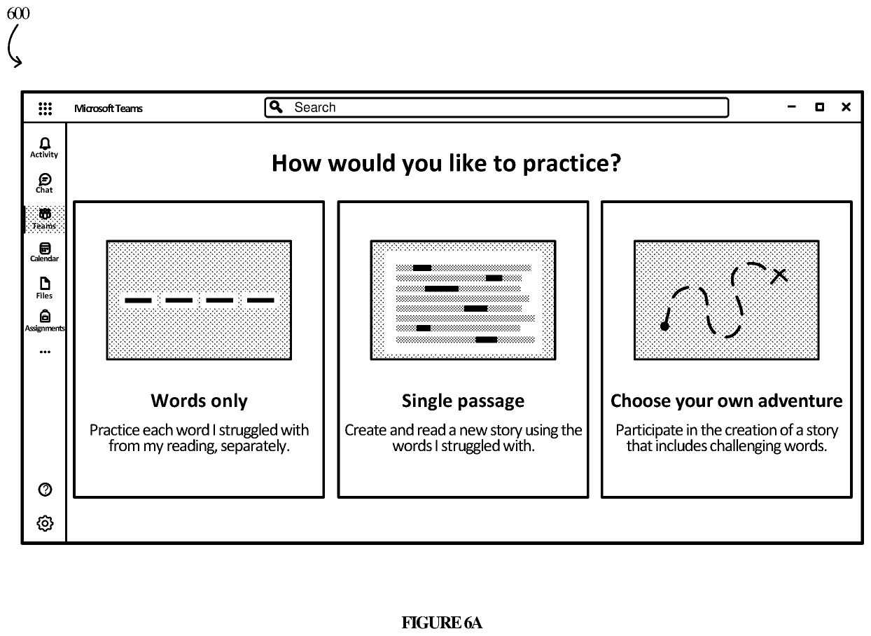

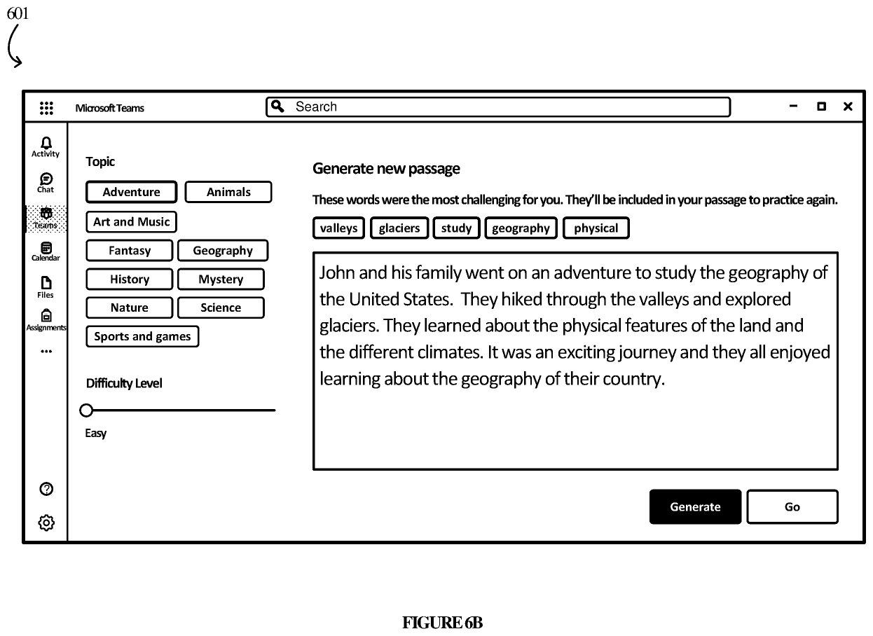

FIGS. 6A and 6B illustrate user experience 600 in an operational scenario of the technology disclosed herein. In FIG. 6A, a student user is presented with the option of practicing reading via student-initiated custom reading passages, such as “Single passage.”

FIG. 6B illustrates user experience 601 when the student user selects “Single passage.” User experience 601 presents trouble words identified by the reading application for that particular user. In an implementation, the student's trouble words were identified by a speech engine or insights engine based on audio data captured of the student reading one or more selected passages. In user experience 601, the student can select a topic and level of difficulty for the passage. Upon clicking “Generate,” the reading application presents the custom reading passage configured according to a prompt generated by the reading application. The prompt generated by the reading application includes the trouble words presented in user experience 600 along with the student-selected parameters, but may include other tasks, instructions, or rules to ensure that the generated content is appropriate (e.g., contains no offensive content). For example, a foundation model (e.g., an LLM) of a foundation model service may be tasked with also incorporating words with phonemes or based on phonics rules with which the student has had difficulty as determined by the speech engine.

In an implementation, the reading application identifies a desired readability based on the reading ability of the student (e.g., age, grade level, sophistication of the trouble words) and evaluates the readability of the custom reading passage received from the foundation model service to determine if the passage satisfies the desired readability. The reading passage illustrated in user experience 601 may be final result of a chain of prompts conditioned on the readability of the passage which task the foundation model service with generating and performing one or more revisions on the reading passage according to the technology described herein.

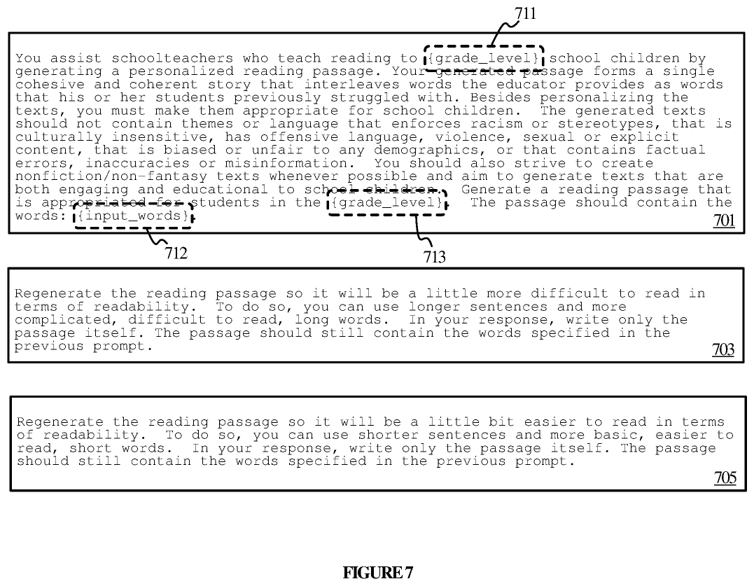

FIG. 7 illustrates prompt templates 701, 703, and 705 including tasks relating to generating and revising reading passages by an LLM (or other foundation model which receives text-based input). Prompt template 701 may be selected by an application service to task the LLM with generating a reading passage according to a desired readability and including a selection of words. In prompt template 701, the desired readability is indicated by a numerical value entered in grade level fields 711 and 713. The numerical value may be determined by the application service based on the grade level of the reader, or it may be inferred based on characteristics of the reader. For example, for a student reader with advanced reading skills, the desired readability may be an effective grade level based on user input specifying a higher level of difficulty and a higher-than-average reading age of the student, resulting in a value that is different from the student's actual grade level. Prompt template 701 also includes input word field 712 for vocabulary to be included in the reading passage, such as trouble words generated by an insights engine.

Prompt templates 703 and 705 in FIG. 7 illustrate templates which may be selected by an application service to revise a reading passage when the reading passage does not achieve a desired readability. In an implementation, prompts based on prompt templates 703 and 705 are submitted with earlier versions of the reading passage and the assessed readability of those versions to guide the LLM in reconfiguring the reading passage to achieve the appropriate level of difficulty.

FIG. 8 illustrates computing device 801 that is representative of any system or collection of systems in which the various processes, programs, services, and scenarios disclosed herein may be implemented. Examples of computing device 801 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 801 may be implemented as a single apparatus, system, or device or may be implemented in a distributed manner as multiple apparatuses, systems, or devices. Computing device 801 includes, but is not limited to, processing system 802, storage system 803, software 805, communication interface system 807, and user interface system 809 (optional). Processing system 802 is operatively coupled with storage system 803, communication interface system 807, and user interface system 809.

Processing system 802 loads and executes software 805 from storage system 803. Software 805 includes and implements reading instruction process 806, which is representative of the reading instruction processes discussed with respect to the preceding Figures, such as process 200. When executed by processing system 802, software 805 directs processing system 802 to operate as described herein for at least the various processes, operational scenarios, and sequences discussed in the foregoing implementations. Computing device 801 may optionally include additional devices, features, or functionality not discussed for purposes of brevity.

Referring still to FIG. 8, processing system 802 may comprise a micro-processor and other circuitry that retrieves and executes software 805 from storage system 803. Processing system 802 may be implemented within a single processing device but may also be distributed across multiple processing devices or sub-systems that cooperate in executing program instructions. Examples of processing system 802 include general purpose central processing units, graphical processing units, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 802 or possibly other systems.

Software 805 (including reading instruction process 806) may be implemented in program instructions and among other functions may, when executed by processing system 802, direct processing system 802 to operate as described with respect to the various operational scenarios, sequences, and processes illustrated herein. For example, software 805 may include program instructions for implementing a reading instruction process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtualization software, or other application software. Software 805 may also comprise firmware or some other form of machine-readable processing instructions executable by processing system 802.

In general, software 805 may, when loaded into processing system 802 and executed, transform a suitable apparatus, system, or device (of which computing device 801 is representative) overall from a general-purpose computing system into a special-purpose computing system customized to custom reading passage generation for reading instruction in an optimized manner. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all be generally referred to herein as a “circuit,” “module” or “system.” Furthermore, aspects of the present invention may take the form of a computer program product embodied in one or more computer readable medium(s) having computer readable program code embodied thereon.

It may be appreciated that, while the inventive concepts disclosed herein are discussed in the context of video conferencing solutions and productivity applications, they apply as well to other contexts such as gaming applications, virtual and augmented reality applications, business applications, and other types of software applications. Likewise, the concepts apply not just to video conferencing content and environments but to other types of content and environments such as productivity applications, gaming applications, and the like.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A computing apparatus comprising:
one or more computer readable storage media;
one or more processors operatively coupled with the one or more computer readable storage media; and
an application comprising program instructions stored on the one or more computer readable storage media that, when executed by the one or more processors, direct the computing apparatus to at least:
generate a prompt with which to elicit, from a foundation model service, a reply that includes a reading passage tailored to a reading ability of a reader, wherein the prompt includes instructions for generating the reading passage using one or more trouble words and according to a desired readability based on one or more indicators of the reading ability of the reader;
assess the readability of the reading passage with respect to the desired readability, resulting an assessed readability;
generate a second prompt with which to elicit, from the foundation model service, a second reply that includes a request to adjust the reading passage based on the assessed readability; and
enable display of the adjusted reading passage in a user interface of the application.

2. The computing apparatus of claim 1, wherein the request to adjust the reading passage comprises a request to make the reading passage more difficult when the assessed readability is below the desired readability.

3. The computing apparatus of claim 1, wherein the request to adjust the reading passage comprises a request to make the reading passage less difficult when the assessed readability is above the desired readability.

4. The computing apparatus of claim 3, wherein the request to adjust the reading passage comprises a request to make the reading passage more difficult when the assessed readability is below the desired readability.

5. The computing apparatus of claim 4, wherein to enable display of the adjusted reading passage in the user interface, the program instructions direct the computing apparatus to enable display of the adjusted reading passage after a maximum number of adjustments to the reading passage.

6. The computing apparatus of claim 5, wherein the assessed readability comprises an estimated grade level.

7. The computing apparatus of claim 6, wherein the estimated grade level is based on an aggregation of scores of the reading passage generated based on one or more scoring metrics.

8. The computing apparatus of claim 1, wherein the one or more indicators of readability comprise one or more of: age, grade level, and level of difficulty.

9. The computing apparatus of claim 1, wherein the program instructions further direct the computing apparatus to:
receive user input comprising a language of the reading passage; and
translate the reading passage into the language.

10. A method of operating an application on a computing device, comprising:
Generating a prompt with which to elicit, from a foundation model service, a reply that includes a reading passage tailored to a reading ability of a reader, wherein the prompt includes instructions for generating the reading passage using one or more trouble words and according to a desired readability based on one or more indicators of the reading ability of the reader;
assessing the readability of the reading passage with respect to the desired readability, resulting an assessed readability;
generating a second prompt with which to elicit, from the foundation model service, a second reply that includes a request to adjust the reading passage based on the assessed readability; and
enabling display of the adjusted reading passage in a user interface of the application.

11. The method of claim 10, wherein the request to adjust the reading passage comprises one of: a request to make the reading passage more difficult when the assessed readability is below the desired readability and a request to make the reading passage less difficult when the readability is above the desired readability.

12. The method of claim 11, wherein enabling display of the adjusted reading passage in the user interface comprises enabling display of the adjusted reading passage after a maximum number of adjustments to the reading passage.

13. The method of claim 12, wherein the assessed readability comprises an estimated grade level.

14. The method of claim 13, wherein estimated grade level is based on an aggregation of scores of the reading passage generated based on one or more scoring metrics.

15. The method of claim 10, wherein the one or more indicators of readability comprise one or more of: age, grade level, and level of difficulty.

16. One or more computer readable storage media having an application comprising program instructions stored thereon that, when executed by one or more processors operatively coupled with the one or more computer readable storage media, direct a computing device to at least:
Generate a prompt with which to elicit, from a foundation model service, a reply that includes a reading passage tailored to a reading ability of a reader, wherein the prompt includes instructions for generating the reading passage using one or more trouble words and according to a desired readability based on one or more indicators of the reading ability of the reader;
assess the readability of the reading passage with respect to the desired readability, resulting an assessed readability;
generate a second prompt with which to elicit, from the foundation model service, a second reply that includes a request to adjust the reading passage based on the assessed readability; and
enable display of the adjusted reading passage in a user interface of the application.

17. The one or more computer readable storage media of claim 16, wherein the request to adjust the reading passage comprises one of: a request to make the reading passage more difficult when the assessed readability is below the desired readability and a request to make the reading passage less difficult when the readability is above the desired readability.

18. The one or more computer readable storage media of claim 17, wherein to enable display of the adjusted reading passage in the user interface, the program instructions direct the computing device to enable display of the adjusted reading passage after a maximum number of adjustments to the reading passage.

19. The one or more computer readable storage media of claim 18, wherein the assessed readability comprises an estimated grade level based on an aggregation of scores of the reading passage generated based on one or more scoring metrics.

20. The one or more computer readable storage media of claim 19, wherein estimated grade level is based on an aggregation of scores of the reading passage generated based on one or more scoring metrics.
